(19) United States
(12) Patent Application Publication
(10) Pub. No.: US 2026/0195009 A1
(43) Pub. Date: Jul. 9, 2026

(54) TOUCH DRIVING DEVICE AND DISPLAY DEVICE

(71) Applicant: LX SEMICON CO., LTD., Daejeon (KR)

(72) Inventors: Gyeong Hwan KIM, Daejeon (KR); Duck Hwan LEE, Daejeon (KR)

(73) Assignee: LX SEMICON CO., LTD., Daejeon (KR)

(21) Appl. No.: 19/132,155

(22) PCT Filed: Nov. 24, 2024
(86) PCT No.: PCT/KR2023/019161

§ 371 Date: May 22, 2025

(30) Foreign Application Priority Data
Nov. 25, 2022 (KR) 10-2022- 0160896
Nov. 24, 2023 (KR) 10-2023- 0165719

(51) Int. Cl. G06F 3/041

(52) U.S. Cl. CPC G06F 3/04182; G06F 3/04164

(57) ABSTRACT

This touch driving device comprises: a plurality of differential signal output circuits that output a plurality of differential sensing signals using a plurality of sensing signals received through a plurality of channels; and a plurality of sensing signal copy circuits that are connected between one of the plurality of channels and at least one among the plurality of differential signal output circuits. Accordingly, virtual noise is not reflected in the differential sensing signal, and thus the misrecognition or malfunction of a touch by an object or the proximity of the object can be prevented.

### TECHNICAL FIELD

Embodiments relate to a touch driving device and a display device.

### BACKGROUND ART

As informatization progresses, various display devices capable of visualizing information are being developed.

A display device may include a panel having a touch function and a touch driving device. Display device are adopted in various electronic devices. Display devices execute desired functions or programs in response to a touch on a panel.

The touch driving device recognizes touch or proximity by an object, based on sensing signals received from a plurality of touch lines of a panel.

In general, panels are vulnerable to noise. Various noises may be introduced into panels. Such noises are reflected in the sensing signals, causing misrecognition or malfunction of touch or proximity by an object.

Therefore, the development of technology capable of removing noise reflected in sensing signals is urgent.

### DISCLOSURE OF INVENTION

### Technical Problem

An object of an embodiment is to solve the above-described problems and other problems.

Another object of an embodiment is to provide a touch driving device and a display device, which are capable of obtaining a sensing signal from which noise is removed.

In addition, still another object of an embodiment is to provide a touch driving device and a display device, which are capable of blocking reflection of virtual noise in a sensing signal.

Technical problems of an embodiment are not limited to those described in this item, but include those that can be understood through the description of the invention.

### Solution to Problem

In order to achieve the above or other objects, according to an aspect of an embodiment, a touch driving device includes a plurality of differential signal output circuits connected to a plurality of channels, and a plurality of sensing signal copy circuits connected between one channel among the plurality of channels and at least one differential signal output circuit among the plurality of differential signal output circuits, wherein the plurality of sensing signal copy circuits copy a sensing signal received from the one channel as a plurality of copy signals and output the plurality of copy signals to a plurality of output terminals, respectively, and wherein the plurality of differential signal output circuits output a differential sensing signal by using one copy signal among the plurality of copy signals output to the plurality of output terminals of the adjacent sensing signal copy circuits, respectively.

The plurality of sensing signal copy circuits may include a first sensing signal copy circuit, a last sensing signal copy circuit, two adjacent sensing signal copy circuits included in a central region, and remaining sensing signal copy circuits.

In each of the first sensing signal copy circuit and the last sensing signal copy circuit, one output terminal among the plurality of output terminals may be connected to one corresponding differential signal output circuit.

In each of the two adjacent sensing signal copy circuits included in the central region, three output terminals among the plurality of output terminals may be connected to three corresponding differential signal output circuits.

In each of the remaining sensing signal copy circuits, two output terminals among the plurality of output terminals may be connected to two corresponding differential signal output circuits.

The touch driving device may include a connection control circuit configured to control connection between the plurality of sensing signal copy circuits and the plurality of differential signal output circuits.

The plurality of differential signal output circuits may be divided into differential signal output circuits included in a first side region and differential signal output circuits included in a second side region with respect to a center line, and the differential signal output circuits included in the first side region and the differential signal output circuits included in the second side region may perform opposite differential operations.

The plurality of sensing signal copy circuits may include copy signal output circuits, respectively.

A number of the plurality of channels, a number of the plurality of differential signal output circuits, and a number of the plurality of sensing signal copy circuits may each be n, and the plurality of sensing signal copy circuits copy the sensing signals as n/2 copy signals.

In order to achieve the above or other objects, according to another aspect of an embodiment, a display device includes a panel including a plurality of touch lines, and a touch driving device including a plurality of channels connected to the plurality of touch lines, wherein the touch driving device includes a plurality of differential signal output circuits connected to the plurality of channels, and a plurality of sensing signal copy circuits connected between one channel among the plurality of channels and at least one differential signal output circuit among the plurality of differential signal output circuits, wherein the plurality of sensing signal copy circuits copy a sensing signal received from the one channel as a plurality of copy signals and output the plurality of copy signals to a plurality of output terminals, respectively, and wherein the plurality of differential signal output circuits output a differential sensing signal by using one copy signal among the plurality of copy signals output to the plurality of output terminals of the adjacent sensing signal copy circuits, respectively.

### Advantageous Effects of Invention

The effects of the touch driving device and the display device according to the embodiments are as follows.

According to at least one of embodiments, a plurality of sensing signal copy circuits each outputting a plurality of copy signals and a plurality of differential signal output circuits selectively receiving a plurality of copy signals output from each of the plurality of sensing signal copy circuits may be included. Accordingly, the plurality of differential signal output circuits may obtain differential sensing signals by using copy signals output from two sensing signal copy circuits, respectively. Therefore, product reliability may be improved by preventing misrecognition or malfunction of touch or proximity by an object because virtual noise is not reflected in the differential sensing signal.

According to at least one of embodiments, the plurality of differential sensing signals are simultaneously obtained through the plurality of differential signal output circuits, thereby shortening the operation time and enabling high-speed operation.

### BRIEF DESCRIPTION OF DRAWINGS

FIG. 1 is a block diagram illustrating a display device according to an embodiment.

FIG. 2 is a diagram illustrating an organic light emitting diode (OLED) panel according to an embodiment.

FIG. 3 illustrates a state in which parasitic capacitance is formed in an in-cell type panel according to an embodiment.

FIG. 4 is a block diagram illustrating a touch driving device according to a first embodiment.

FIG. 5 is a block diagram illustrating a touch driving device according to a second embodiment.

FIG. 6 is a circuit diagram illustrating a first sensing signal copy circuit according to an embodiment.

FIG. 7 is a circuit diagram illustrating a plurality of differential signal output circuits according to an embodiment.

The sizes, shapes, and dimensions of components illustrated in the drawings may differ from the actual sizes, shapes, and dimensions. In addition, even when the same components are illustrated in different sizes, shapes, and dimensions between the drawings, this is only an example in the drawings, and the same components may have the same sizes, shapes, and dimensions between the drawings.

### MODE FOR THE INVENTION

Hereinafter, embodiments disclosed in the present specification will be described in detail with reference to the accompanying drawings. The same or similar components are denoted by the same reference numerals, regardless of the reference numerals, and redundant descriptions thereof are omitted. The suffixes ‘module’ and ‘unit’ for components used in the following description are assigned or mixed in consideration of easiness in writing the specification and do not have distinctive meanings or roles by themselves. Additionally, the accompanying drawings are used to understanding embodiments disclosed in the present specification, but the technical concept disclosed in the present specification is not limited by the accompanying drawings. Additionally, when a component such as a layer, a region, or a substrate is referred to as being ‘on’ another component, it will be understood that the component may be directly on the other component, or intervening components may be present therebetween.

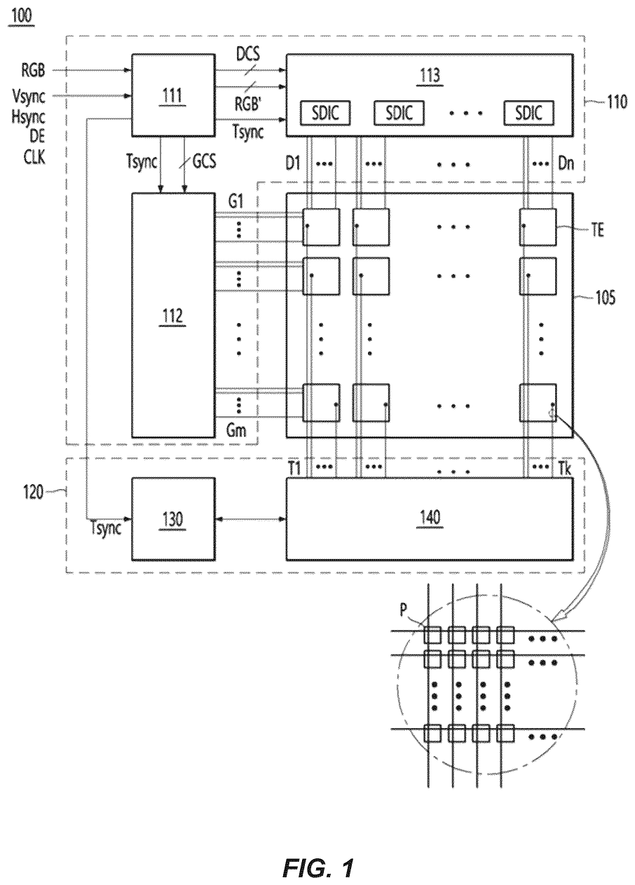

FIG. 1 is a block diagram illustrating a display device according to an embodiment.

Referring to FIG. 1, a display device 100 according to an embodiment may include a panel 105, a display driving device 110, a touch driving device 120, etc.

The display device 100 according to an embodiment may perform a display function and a touch sensing function. The display device 100 according to an embodiment may be implemented as a flat display such as a liquid crystal display or an organic light-emitting diode display.

The panel 105 may include a plurality of touch sensors TE capable of outputting sensing signals for touch or proximity of an object.

When the panel 105 is a liquid crystal panel, touch sensing may be performed in an in-cell type. That is, the plurality of touch sensors TE may be embedded into the liquid crystal panel. The liquid crystal panel may be time-divided into a display period and a touch period in units of frames. The plurality of touch sensors TE may be used as common electrodes during the display period and may be used as touch electrodes during the touch period.

The in-cell type may be divided into an in-cell type using a self-capacitance type and an in-cell types using a mutual capacitance type.

When the panel 105 is an organic light emitting diode (OLED) panel, touch sensing may be performed in an on-cell type or an added-on type. That is, the plurality of touch sensors TE may be positioned on the OLED panel. In this case, the display period and the touch period may operate simultaneously. For example, one frame may be used entirely as the display period and simultaneously as the touch period. That is, touch sensing may be performed by using the touch sensors TE while an image is displayed on the OLED panel during one frame.

The panel 105 may include a plurality of gate lines G1 to Gm, a plurality of data lines D1 to Dn, a plurality of pixels P, a plurality of touch sensors TE, a plurality of touch lines T1 to Tk, etc.

Each of the plurality of gate lines G1 to Gm may receive a scan pulse during the display period. Each of the plurality of data lines D1 to Dn may receive a data signal during the display period. The plurality of gate lines G1 to Gm and the plurality of data lines D1 to Dn may be arranged to cross each other on the substrate. The plurality of gate lines G1 to Gm and the plurality of data lines D1 to Dn may be respectively connected to the plurality of pixels P on the substrate. The plurality of pixels P may respectively include thin film transistors connected to the gate lines G1 to Gm and the data lines D1 to Dn, the pixels P electrodes connected to the thin film transistors, storage capacitors connected to the pixels P electrode, etc.

Since each of the plurality of touch sensors TE is used as a self-capacitance type touch sensor during the touch period, each of the plurality of touch sensors TE may have a size larger than a minimum contact size between the touch object and the panel 105. For example, the size of the touch sensor TE may correspond to the size of one pixel P, or may correspond to the size of the plurality of pixels P. The plurality of touch sensors TE may be arranged along a plurality of horizontal lines and a plurality of vertical lines. The plurality of touch lines T1 to Tk may be individually connected to the plurality of touch sensors TE, but the present disclosure is not limited thereto.

The display driving device 110 may supply data signals to the plurality of pixels P so that an image is displayed on the panel 105 during the display period. The display driving device 110 may include a data processing device 111, a gate driving device 112, a data driving device 113, etc. The data processing device 111 may include a timing controller.

The data processing device 111 may receive various timing signals from a host system. The timing signals may include a vertical synchronization signal Vsync, a horizontal synchronization signal Hsync, a data enable signal DE, a clock signal CLK, etc. The data processing device 111 may generate various control signals based on the timing signals.

For example, the control signals may generate a gate control signal GCS for controlling the gate driving device 112 and a data control signal DCS for controlling the data driving device 113. The data processing device 111 may receive an image signal, i.e., digital image data RGB, from the host system and convert the image signal into an image signal RGB′ in a form that may be processed by the data driving device 113.

The data processing device 111 may generate a touch synchronization signal Tsync by using the clock signal CLK, the vertical synchronization signal Vsync, the data enable signal, etc. The data processing device 111 may transmit the touch synchronization signal Tsync to the gate driving device 112, the data driving device 113, the touch controller 130, etc.

In the in-cell type, each of the gate driving device 112, the data driving device 113, and the touch controller 130 may time-divide the plurality of display periods and the plurality of touch periods by using the touch synchronization signal Tsync. For example, the display periods and the touch periods may be allocated so that the display periods and the touch periods are positioned alternately.

Alternatively, the data processing device 111 may time-divide the plurality of display periods and the plurality of touch periods by using the touch synchronization signal Tsync. In this case, instead of the touch synchronization signal Tsync, the data processing device 111 may transmit control signals regarding the plurality of time-divided display periods and the plurality of time-divided touch periods to each of the gate driving device 112, the data driving device 113, and the touch controller 130.

The host system converts the digital image data RGB into the image signal RGB′ having a format suitable for display on the panel 105. The host system may transmit the timing signals Vsync, Hsync, DE, and CLK together with the image signal RGB′ to the data processing device 111. The host system may be implemented as a television system, a set-top box, a navigation system, a DVD player, a Blu-ray player, a personal computer (PC), a home theater system, a mobile system, an automotive, marine or aviation electronic system, etc.

On the other hand, the host system may receive touch input coordinates from the touch driving device 120 and execute an application program linked to the received touch input coordinates or perform a corresponding operation.

The gate driving device 112 may receive the gate control signal GCS from the data processing device 111 during the display period. The gate driving device 112 may generate a scan pulse in response to the gate control signal GCS. The scan pulse may be provided to the corresponding pixels P of the panel 105 through the corresponding gate lines G1 to Gm.

The gate driving device 112 supplies the scan pulse to the gate lines G1 to Gm during the display period, but may not supply the scan pulse to the gate lines G1 to Gm during the touch period. That is, the gate lines G1 to Gm may be maintained at a high level during the display period, and the gate lines G1 to Gm may be maintained at a low level during the touch period. Accordingly, the scan pulse is supplied during the display period to select the pixels P connected to the corresponding gate lines G1 to Gm, and the gate lines G1 to Gm are maintained at a low level during the touch period to prevent fluctuations in the output of the touch sensors TE.

The data driving device 113 may receive the data control signal DCS and the image signal RGB′ from the data processing device 111 during the display period. The data driving device 113 may convert the image signal RGB′ into an analog data signal by using the data control signal DCS and supply the data signal to pixels P through the plurality of data lines D1 to Dn.

The data driving device 113 may include a plurality of source drive integrated circuits SDIC. One source drive integrated circuit SDIC may be connected to the plurality of data lines D1 to Dn, and thus, one source drive integrated circuit SDIC may supply the plurality of data signals to the panel 105 through the plurality of data lines D1 to Dn.

The touch driving device 120 may include a touch controller 130, a touch sensing circuit 140, etc. The touch controller 130 may be referred to as a touch microcontroller unit, etc.

The touch controller 130 may perform the touch sensing operation during the touch period. The touch controller 130 may control the touch sensing circuit 140 to perform the touch sensing operation during the touch period.

The touch controller 130 may obtain touch coordinates based on the touch sensing signal received through the touch sensing circuit 140 and execute an application program corresponding to the touch coordinates or perform a corresponding operation. The touch controller 130 may transmit information including the corresponding touch coordinates to the data processing device 111. In this case, the data processing device 111 may execute an application corresponding to the touch coordinates or perform a corresponding operation, based on information including the touch coordinates received from the touch controller 130.

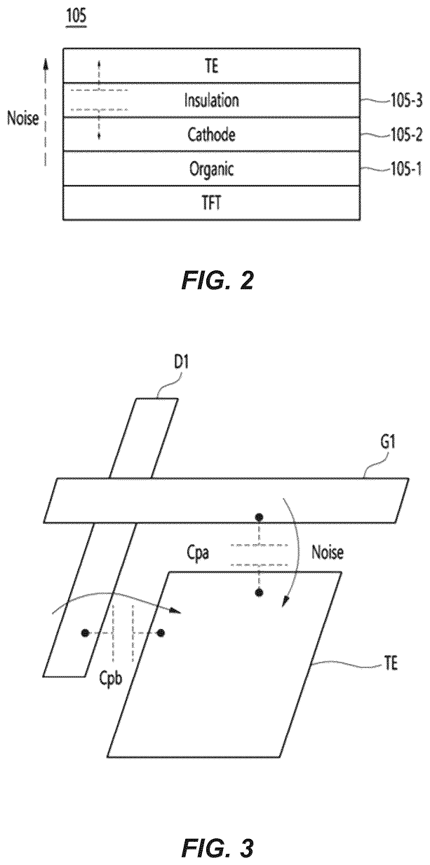

FIG. 2 is a diagram illustrating an OLED panel according to an embodiment.

Referring to FIG. 2, the panel 105 may include a display panel and a touch panel. The display panel may include a TFT substrate, an OLED layer 105-1, a cathode electrode 105-2, and an insulating layer 105-3. The touch panel may include a plurality of touch sensors TE.

A thin film transistor and an anode electrode arranged in a pixel may be arranged on the TFT substrate. The OLED layer 105-1 may include a plurality of organic emission layers made of an organic light emitting material that emits light by electric energy. The cathode electrode 105-2 that supplies a base voltage to the OLED layer 105-1 may be arranged on the cathode electrode 105-2. The TFT substrate, the OLED layer 105-1, and the cathode electrode 105-2 may be collectively referred to as a display electrode layer.

The gate line, the data line, the anode electrode, the cathode electrode 105-2, etc. may be arranged on the display electrode layer. The insulating layer 105-3 or the like may be arranged between the display electrode layer and the touch sensor TE. Due to the insulating layer 105-3, parasitic capacitance may be formed between the display electrode and the touch sensor TE.

The touch driving signal supplied to the touch sensor TE may be affected by the parasitic capacitance. The touch sensor TE may receive noise from the display panel through the parasitic capacitance. That is, noise may be included in the sensing signal output from the touch sensor TE.

On the other hand, the in-cell type panel in which part of the display panel and part of the touch panel are shared may be provided.

FIG. 3 illustrates a state in which parasitic capacitance is formed in the in-cell type panel according to an embodiment.

Referring to FIG. 3, the touch sensor TE may be embedded into the display panel.

The display panel may be a liquid crystal panel. In such cases, a common electrode to which a common voltage is supplied may be used as the touch sensor TE. In this case, a first parasitic capacitance Cpa may be formed between the touch sensor TE and the gate line G, and a second parasitic capacitance Cpb may be formed between the touch sensor TE and the data line D.

The touch sensor TE may receive noise from the display panel through the first parasitic capacitance Cpa and the second parasitic capacitance Cpb. That is, noise may be included in the sensing signal output from the touch sensor TE.

As described above, sensing signals including noise may cause misrecognition or malfunction of touch or proximity by an object.

Hereinafter, a device or a method capable of preventing misrecognition or malfunction of touch or proximity by an object by removing noise from a sensing signal is described.

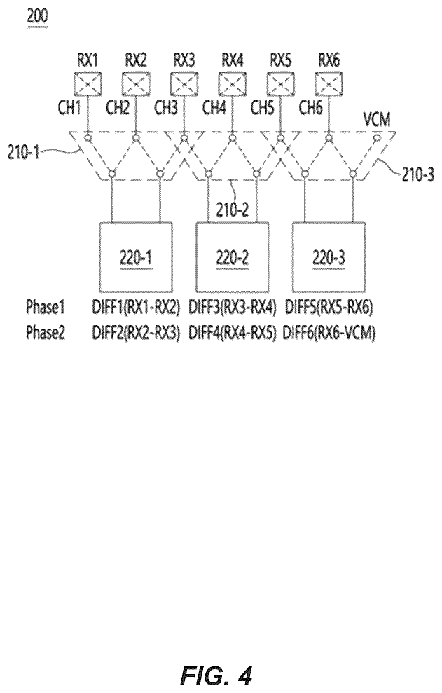

FIG. 4 is a block diagram illustrating a touch driving device according to a first embodiment.

Referring to FIG. 4, a touch driving device 200 according to a first embodiment may include a plurality of multiplexers 210-1 to 210-3, a plurality of differential signal output circuits 220-1 to 220-3, etc. Here, the touch driving device 200 may be the touch driving device 120 or the touch sensing circuit 140 illustrated in FIG. 1. The differential signal output circuit 220-1 to 220-3 may be referred to as a charge voltage converter (CVC).

The plurality of multiplexers 210-1 to 210-3 may receive a plurality of sensing signals RX1 to RX6 through a plurality of channels CH1 to CH6. The plurality of channels CH1 to CH6 may be connected to a plurality of touch lines on a panel, and the plurality of touch lines may be connected to a plurality of touch sensors.

Six channels CH1 to CH6, three multiplexers 210-1 to 210-3, and three differential signal output circuits 220-1 to 220-3 are illustrated, but more channels, more multiplexers, and more differential signal output circuits may be provided.

The multiplexers 210-1 to 210-3 may be 3:2 multiplexers. For example, the multiplexers 210-1 to 210-3 may output two sensing signals among the sensing signals received on three channels.

The first multiplexer 210-1 may output two sensing signals among the first to third sensing signals RX1 to RX3 received through the first to third channels CH1 to CH3. For example, the first sensing signal RX1 and the second sensing signal RX2, or the second sensing signal RX2 and the third sensing signal RX3 may be output.

The second multiplexer 210-2 may output two sensing signals among the third to fifth sensing signals RX3 to RX5 received through the third to fifth channels CH3 to CH5. For example, the third sensing signal RX3 and the fourth sensing signal RX4, or the fourth sensing signal RX4 and the fifth sensing signal RX5 may be output.

The last multiplexer, i.e., the third multiplexer 210-3, may output two sensing signals among the fifth sensing signal RX5, the sixth sensing signal RX6, and the virtual signal VCOM. The virtual signal VCOM may be a virtual noise. The fifth sensing signal RX5 and the sixth sensing signal RX6 may be received through the fifth channel CH5 and the sixth channel CH6, respectively. For example, the fifth sensing signal RX5 and the sixth sensing signal RX6, or the sixth sensing signal RX6 and the virtual signal VCOM may be output.

The plurality of differential signal output circuits 220-1 to 220-3 may be connected to the plurality of multiplexers 210-1 to 210-3, respectively.

The first differential signal output circuit 220-1 may be connected to the first multiplexer 210-1 and may output a differential signal by using two sensing signals output from the first multiplexer 210-1. The second differential signal output circuit 220-2 may be connected to the second multiplexer 210-2 and may output a differential signal by using two sensing signals output from the second multiplexer 210-2. The third differential signal output circuit 220-3 may be connected to the third multiplexer 210-3 and may output a differential signal by using two sensing signals output from the third multiplexer 210-3.

On the other hand, the plurality of multiplexers 210-1 to 210-3 and the plurality of differential signal output circuits 220-1 to 220-3 may be operated in a first phase mode (Phase 1) and a second phase mode (Phase 2). The first phase mode (Phase 1) and the second phase mode (Phase 2) may be operated sequentially, but the present disclosure is not limited thereto.

In the first phase mode (Phase 1), the first multiplexer 210-1 may output the first sensing signal RX1 and the second sensing signal RX2, the second multiplexer 210-2 may output the third sensing signal RX3 and the fourth sensing signal RX4, and the third multiplexer 210-3 may output the fifth sensing signal RX5 and the sixth sensing signal RX6. In the first phase mode (Phase 1), the first differential signal output circuit 220-1 may output a first differential sensing signal DIFF1 by using the first sensing signal RX1 and the second sensing signal RX2. In the first phase mode (Phase 1), the second differential signal output circuit 220-2 may output a third differential sensing signal DIFF3 by using the third sensing signal RX3 and the fourth sensing signal RX4. In the first phase mode (Phase 1), the third differential signal output circuit 220-3 may output a fifth differential sensing signal DIFF by using the fifth sensing signal RX5 and the sixth sensing signal RX6.

In the second phase mode (Phase 2), the first multiplexer 210-1 may output the second sensing signal RX2 and the third sensing signal RX3, the second multiplexer 210-2 may output the fourth sensing signal RX4 and the fifth sensing signal RX5, and the third multiplexer 210-3 may output the sixth sensing signal RX6 and the virtual signal VCOM. In the second phase mode (Phase 2), the first differential signal output circuit 220-1 may output a second differential sensing signal DIFF2 by using the second sensing signal RX2 and the third sensing signal RX3. In the second phase mode (Phase 2), the second differential signal output circuit 220-2 may output a fourth differential sensing signal DIFF4 by using the fourth sensing signal RX4 and the fifth sensing signal RX5. In the second phase mode (Phase 2), the third differential signal output circuit 220-3 may output a sixth differential sensing signal DIFF6 by using the sixth sensing signal RX6 and the virtual signal VCOM.

The first differential sensing signal DIFF1 may be a difference value between the first sensing signal RX1 and the second sensing signal RX2, the second differential sensing signal DIFF2 may be a difference value between the second sensing signal RX2 and the third sensing signal RX3, and the third differential sensing signal DIFF3 may be a difference value between the third sensing signal RX3 and the fourth sensing signal RX4, but is not limited thereto. The fourth differential sensing signal DIFF4 may be a difference value between the fourth sensing signal RX4 and the fifth sensing signal RX5, the fifth differential sensing signal DIFF5 may be a difference value between the fifth sensing signal RX5 and the sixth sensing signal RX6, and the sixth differential sensing signal DIFF6 may be a difference value between the sixth sensing signal RX6 and the virtual signal VCOM, but is not limited thereto.

The touch or proximity by an object may be recognized by using the first to sixth sensing signals RX1 to RX6.

On the other hand, the virtual signal VCOM may be the virtual noise rather than the sensing signal actually received through the channel. Virtual noise may occur anytime and anywhere. Therefore, the virtual noise may vary at each sensing point. That is, at some sensing points, the virtual noise may be 0, and at other sensing points, the virtual noise may have a value greater than the magnitude of the sensing signals received from the first to sixth channels CH1 to CH6.

Therefore, since the touch coordinates obtained by using the first to sixth differential sensing signals DIFF1 to DIFF6 are inaccurate, misrecognition or malfunction of touch or proximity by an object may occur. For example, a ghost touch in which an area that was not actually touched is perceived as being touched may occur, or a touch insensitivity phenomenon in which no touch action is performed even though an area was actually touched may occur.

In addition, since the first embodiment operates in a two-stage mode including the first phase mode (Phase 1) and the second phase mode (Phase 2), there is a problem that an operation time increases and high-speed operation is limited.

As described above, since the virtual signal VCOM is reflected in the differential sensing signals DIFF1 to DIFF6, misrecognition or malfunction of touch or proximity by an object occurs, and therefore, it is necessary to develop a technology to prevent the virtual signal VCOM from being reflected in the differential sensing signals DIFF1 to DIFF6.

To solve these problems, a second embodiment is proposed, and the second embodiment is described in detail below.

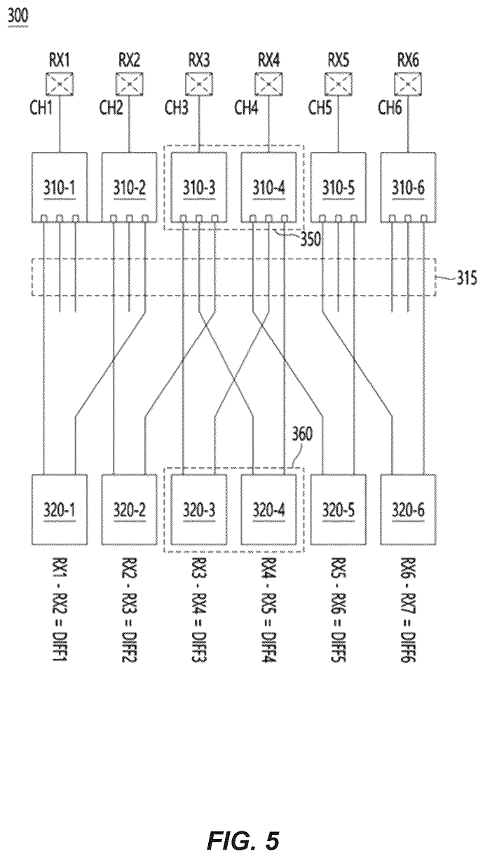

FIG. 5 is a block diagram illustrating a touch driving device according to a second embodiment.

Referring to FIG. 5, the touch driving device 300 according to the second embodiment may include a plurality of sensing signal copy circuits 310-1 to 310-6, a plurality of differential signal output circuits 320-1 to 320-6, etc. Here, the touch driving device 300 may be the touch driving device 120 or the touch sensing circuit 140 illustrated in FIG. 1. The sensing signal copy circuits 310-1 to 310-6 may be referred to as current conveyors. The differential signal output circuits 320-1 to 320-6 may be referred to as charge voltage converters.

The plurality of sensing signal copy circuits 310-1 to 310-6 may receive a plurality of sensing signals RX1 to RX6 through a plurality of channels CH1 to CH6. The plurality of channels CH1 to CH6 may be connected to a plurality of touch lines on a panel, and the plurality of touch lines may be connected to a plurality of touch sensors.

Six channels CH1 to CH6, six sensing signal copy circuits 310-1 to 310-6, and six differential signal output circuits 320-1 to 320-6 are illustrated, but more channels, more multiplexers, and more differential signal output circuits may be provided.

The plurality of sensing signal copy circuits 310-1 to 310-6 may be connected between one channel among the plurality of channels CH1 to CH6 and at least one differential signal output circuit among the plurality of differential signal output circuits 320-1 to 320-6.

Each of the plurality of channels CH1 to CH6 may be connected to the plurality of sensing signal copy circuits 310-1 to 310-6.

The first channel CH1 may be connected to the first sensing signal copy circuit 310-1 so that the first sensing signal RX1 may be supplied to the first sensing signal copy circuit 310-1 through the first channel CH1. The second channel CH2 may be connected to the second sensing signal copy circuit 310-2 so that the second sensing signal RX2 may be supplied to the second sensing signal copy circuit 310-2 through the second channel CH2. The third channel CH3 may be connected to the third sensing signal copy circuit 310-3 so that the third sensing signal RX3 may be supplied to the third sensing signal copy circuit 310-3 through the third channel CH3.

The fourth channel CH4 may be connected to the fourth sensing signal copy circuit 310-4 so that the fourth sensing signal RX4 may be supplied to the fourth sensing signal copy circuit 310-4 through the fourth channel CH4. The fifth channel CH5 may be connected to the fifth sensing signal copy circuit 310-5 so that the fifth sensing signal RX5 may be supplied to the fifth sensing signal copy circuit 310-5 through the fifth channel CH5. The sixth channel CH6 may be connected to the sixth sensing signal copy circuit 310-6 so that the sixth sensing signal RX6 may be supplied to the sixth sensing signal copy circuit 310-6 through the sixth channel CH6.

Each of the plurality of sensing signal copy circuits 310-1 to 310-6 may be connected to at least one differential signal output circuit.

As illustrated in FIG. 5, the plurality of sensing signal copy circuits 310-1 to 310-6 may include the first sensing signal copy circuit 310-1, the last sensing signal copy circuit 310-6, the two adjacent sensing signal copy circuits 310-3 and 310-4 included in a central region 350, and the remaining sensing signal copy circuits 310-2 and 310-5. The plurality of differential signal output circuits 320-1 to 320-6 may include the first differential signal output circuit 320-1, the last differential signal output circuit 320-6, the two adjacent differential signal output circuits 320-3 and 320-4 included in a central region 360, and the remaining differential signal output circuits 320-2 and 320-5.

In this case, the first sensing signal copy circuit 310-1 may be connected to the first differential signal output circuit 320-1. The last sensing signal copy circuit, i.e., the sixth sensing signal copy circuit 310-6, may be connected to the last differential signal output circuit, i.e., the sixth differential signal output circuit 320-6.

The two adjacent sensing signal copy circuits included in the central region 350, i.e., the third sensing signal copy circuit 310-3 and the fourth sensing signal copy circuit 310-4, may each be connected to three differential signal output circuits. For example, the third sensing signal copy circuit 310-3 may be connected to the second to fourth sensing signal output circuits 320-2 to 320-4. For example, the fourth sensing signal copy circuit 310-4 may be connected to the third to fifth sensing signal output circuits 320-3 to 320-5.

The remaining sensing signal copy circuits, i.e., the second sensing signal copy circuit 310-2 and the fifth sensing signal copy circuit 310-5, may each be connected to the two differential signal output circuits. For example, the second sensing signal copy circuit 310-2 may be connected to the first differential signal output circuit 320-1 and the second differential signal output circuit 320-2. The fifth sensing signal copy circuit 310-5 may be connected to the fifth differential signal output circuit 320-5 and the sixth differential signal output circuit 320-6.

Each of the plurality of sensing signal copy circuits 310-1 to 310-6 may output a plurality of copy signals through a plurality of output terminals.

For example, the first sensing signal copy circuit 310-1 may copy the first sensing signal RX1 received through the first channel CH1 as the plurality of copy signals and output the plurality of copy signals through the plurality of output terminals. For example, the second sensing signal copy circuit 310-2 may copy the second sensing signal RX2 received through the second channel CH2 as the plurality of copy signals and output the plurality of copy signals through the plurality of output terminals. The third sensing signal copy circuit 310-3 may copy the third sensing signal RX3 received through the third channel CH3 as the plurality of copy signals and output the plurality of copy signals through the plurality of output terminals.

For example, the fourth sensing signal copy circuit 310-4 may copy the fourth sensing signal RX4 received through the fourth channel CH4 as the plurality of copy signals and output the plurality of copy signals through the plurality of output terminals. For example, the fifth sensing signal copy circuit 310-5 may copy the fifth sensing signal RX5 received through the fifth channel CH5 as the plurality of copy signals and output the plurality of copy signals through the plurality of output terminals. For example, the plurality of sixth sensing signal copy circuits 310-6 may copy the sixth sensing signal RX6 received through the sixth channel CH6 as the plurality of copy signals and output the plurality of copy signals through the plurality of output terminals.

Since the copy signals output from the first to sixth sensing signal copy circuits 310-1 to 310-6 are the same as the sensing signals RX1 to RX6 input from the first to sixth channels CH1 to CH6, the sensing signals RX1 to RX6 and the copy signals may be interchangeably used. In contrast, although the copy signals have the same current value as the sensing signals RX1 to RX6, the magnitudes thereof may be different from each other. For example, the current values of the copy signals may be greater than the current values of the sensing signals RX1 to RX6, but the present disclosure is not limited thereto.

On the other hand, the plurality of copy signals output from the plurality of sensing signal copy circuits 310-1 to 310-6 may be selectively supplied to one or more differential signal output circuits.

For example, one copy signal among the plurality of copy signals output from the plurality of output terminals of the first sensing signal copy circuit 310-1 may be supplied to the first differential signal output circuit 320-1. Two copy signals among the plurality of copy signals output to the plurality of output terminals of the second sensing signal copy circuit 310-2 may be supplied to the first differential signal output circuit 320-1 and the second differential signal output circuit 320-2, respectively. The plurality of copy signals output to the plurality of output terminals of the third sensing signal copy circuit 310-3 may be supplied to the second to fourth differential signal output circuits 320-2 to 320-4, respectively.

The plurality of copy signals output to the plurality of output terminals of the fourth sensing signal copy circuit 310-4 may be supplied to the third to fifth differential signal output circuits 320-3 to 320-5, respectively. Two copy signals among the plurality of copy signals output to the plurality of output terminals of the fifth sensing signal copy circuit 310-5 may be supplied to the fifth differential signal output circuit 320-5 and the sixth differential signal output circuit 320-6, respectively. One copy signal among the plurality of copy signals output to the plurality of output terminals of the sixth sensing signal copy circuit 310-6 may be supplied to the sixth differential signal output circuit 320-6.

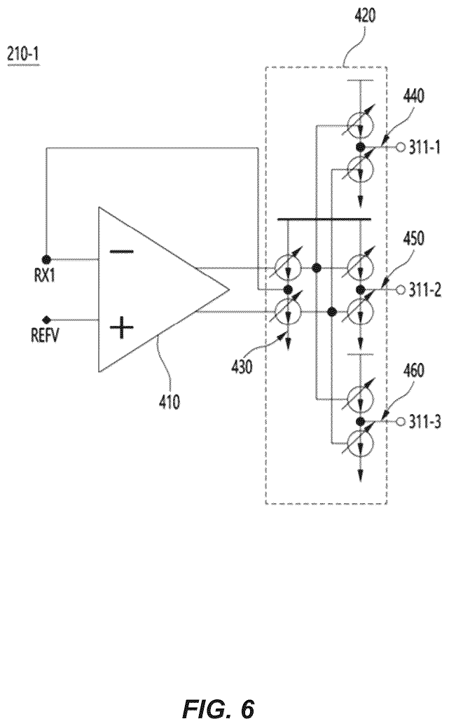

On the other hand, the plurality of sensing signal copy circuits 310-1 to 310-6 may copy the sensing signals RX1 to RX6 received through the plurality of channels CH1 to CH6 as the plurality of copy signals and output the plurality of copy signals to the plurality of output terminals. This is described in more detail with reference to FIG. 6.

FIG. 6 is a circuit diagram illustrating the first sensing signal copy circuit according to an embodiment.

As illustrated in FIGS. 1, 5, and 6, the first sensing signal copy circuit 310-1 may include an amplifier 410, a copy signal output circuit 420, etc.

The first sensing signal RX1 received through the first channel CH1 may be input to an inverting (−) terminal of the amplifier 410. A reference value REFV, etc. may be input to a non-inverting (+) terminal of the amplifier 410. The reference value REFV may be supplied to the touch sensor TE on the panel 105 as a driving signal. Accordingly, the first sensing signal RX1 may be amplified and output by the amplifier 410.

The copy signal output circuit 420 may be connected to the output terminal of the amplifier 410 and may copy the first sensing signal RX1 output from the amplifier 410 as the plurality of copy signals and output the plurality of copy signals.

The copy signal output circuit 420 may include a first current circuit 430, a plurality of second current circuits 440 to 460, etc.

The first current circuit 430 may be connected to the output terminal of the amplifier 410 and may output a current value corresponding to the first sensing signal RX1 output from the amplifier 410, i.e., a corresponding signal.

The plurality of second current circuits 440 to 460 may copy the corresponding signal as the plurality of copy signals and output the plurality of copy signals. Here, the corresponding signal or the copy signal may be a current value, but is not limited thereto. The current value of the copy signal and the current value of the corresponding signal may be different from each other, but the present disclosure is not limited thereto.

The second current circuits 440 to 460 may output the plurality of copy signals through the plurality of output terminals, respectively.

On the other hand, the second to sixth sensing signal copy circuits 310-2 to 310-6 also have the same circuit structure as the first sensing signal copy circuit 310-1 illustrated in FIG. 6, and thus may be easily understood from the description of the first sensing signal copy circuit 310-1 related to FIG. 6.

On the other hand, as illustrated in FIGS. 5 and 6, the number of the plurality of channels CH1 to Ch6, the number of the plurality of differential signal output circuits 320-1 to 320-6, and the number of the plurality of sensing signal copy circuits 310-1 to 310-6 may each be n. In this case, the plurality of sensing signal copy circuits 310-2 to 310-6 may copy the sensing signal as n/2 copy signals.

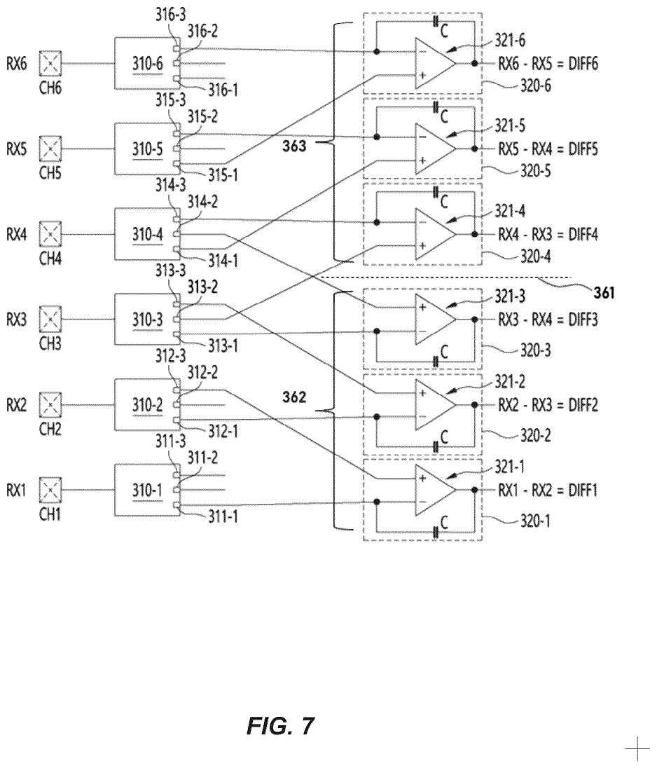

FIG. 7 is a circuit diagram illustrating the plurality of differential signal output circuits according to an embodiment.

As illustrated in FIG. 7, the plurality of differential signal output circuits 320-1 to 320-6 may be divided into differential signal output circuits 320-1 to 320-3 included in a first side region 362 and differential signal output circuits 320-4 to 320-6 included in a second side region 363 with respect to a center line 361. The center line 361 may be, for example, a virtual line positioned between the third differential signal output circuit 320-3 and the fourth differential signal output circuit 320-4.

In this case, the differential signal output circuits 320-1 to 320-3 included in the first side region 362 and the differential signal output circuits 320-4 to 320-6 included in the second side region 363 may perform opposite differential operations.

For example, the differential signal output circuits included in the first side region 362, i.e., the first to third differential signal output circuits 320-1 to 320-3, may each perform a differential operation of subtracting a sensing signal input through an upper channel from a sensing signal input through a lower channel. The first differential signal output circuit 320-1 may output the first differential sensing signal DIFF1 by subtracting the second sensing signal RX2 from the first sensing signal RX1. The second differential signal output circuit 320-2 may output the second differential sensing signal DIFF2 by subtracting the third sensing signal RX3 from the second sensing signal RX2. The third differential signal output circuit 320-3 may output the third differential sensing signal DIFF3 by subtracting the fourth sensing signal RX4 from the third sensing signal RX3.

In contrast, the differential signal output circuits included in the second side region 363, i.e., the fourth to sixth differential signal output circuits 320-4 to 320-6, may each perform a differential operation of subtracting a sensing signal input through a lower channel from a sensing signal input through an upper channel. The fourth differential signal output circuit 320-4 may output the fourth differential sensing signal DIFF4 by subtracting the third sensing signal RX3 from the fourth sensing signal RX4. The fifth differential signal output circuit 320-5 may output the fifth differential sensing signal DIFF5 by subtracting the fourth sensing signal RX4 from the fifth sensing signal RX5. The sixth differential signal output circuit 320-6 may output the sixth differential sensing signal DIFF6 by subtracting the fifth sensing signal RX5 from the sixth sensing signal RX6.

As such, the differential signal output circuits 320-1 to 320-3 included in the first side region 362 and the differential signal output circuits 320-4 to 320-6 included in the second side region 363 may perform opposite differential operations so that the plurality of differential sensing signals DIFF1 to DIFF6 may be obtained. Accordingly, there is no need to use a virtual signal VCOM when obtaining the plurality of differential sensing signals DIFF1 to DIFF6. Accordingly, by obtaining the plurality of differential signals only by using the sensing signals RX1 to RX6 input to the plurality of channels CH1 to CH6 without using the virtual signal VCOM, misrecognition or malfunction of touch or proximity by an object due to reflection of the virtual signal VCOM in the differential sensing signals DIFF1 to DIFF6 may be prevented, thereby improving product reliability.

In addition, since the plurality of differential sensing signals DIFF1 to DIFF6 are simultaneously obtained through the plurality of differential signal output circuits 320-1 to 320-6, the operating time may be shortened and high-speed operation may be possible.

On the other hand, the plurality of differential signal output circuits 320-1 to 320-6 may include differential amplifiers 321-1 to 321-6, respectively.

The differential amplifiers 321-1 to 321-6 may output a difference value between the signal input to the inverting terminal (−) and the signal input to the non-inverting terminal (+) as the output signal, i.e., the differential sensing signal, but the present disclosure is not limited thereto.

A first output terminal 311-1 of the first sensing signal copy circuit 310-1 may be connected to an inverting (−) terminal of the differential amplifier 321-1 of the first differential signal output circuit 320-1. A third output terminal 312-3 of the second sensing signal copy circuit 310-2 may be connected to a non-inverting (+) terminal of the differential amplifier 321-1 of the first differential signal output circuit 320-1. Accordingly, the differential amplifier 321-1 of the first differential signal output circuit 320-1 may output the difference value between the copy signal output from the first output terminal 311-1 of the first sensing signal copy circuit 310-1, i.e., the first sensing signal RX1, and the copy signal output from the third output terminal 312-3 of the second sensing signal copy circuit 310-2, i.e., the second sensing signal RX2, as the first differential sensing signal DIFF1.

A first output terminal 312-1 of the second sensing signal copy circuit 310-2 may be connected to an inverting (−) terminal of the differential amplifier 321-2 of the second differential signal output circuit 320-2. A third output terminal 313-3 of the third sensing signal copy circuit 310-3 may be connected to a non-inverting (+) terminal of the differential amplifier 321-2 of the second differential signal output circuit 320-2. Accordingly, the differential amplifier 321-2 of the second differential signal output circuit 320-2 may output the difference value between the copy signal output from the first output terminal 312-1 of the second sensing signal copy circuit 310-2, i.e., the second sensing signal RX2, and the copy signal output from the third output terminal 313-3 of the third sensing signal copy circuit 310-3, i.e., the third sensing signal RX3, as the second differential sensing signal DIFF2.

A first output terminal 313-1 of the third sensing signal copy circuit 310-3 may be connected to an inverting (−) terminal of the differential amplifier 321-3 of the third differential signal output circuit 320-3. A second output terminal 314-2 of the fourth sensing signal copy circuit 310-4 may be connected to a non-inverting (+) terminal of the differential amplifier 321-3 of the third differential signal output circuit 320-3. Accordingly, the differential amplifier 321-3 of the third differential signal output circuit 320-3 may output the difference value between the copy signal output from the first output terminal 313-1 of the third sensing signal copy circuit 310-3, that is, the third sensing signal RX3, and the copy signal output from the second output terminal 314-2 of the fourth sensing signal copy circuit 310-4, that is, the fourth sensing signal RX4, as the third differential sensing signal DIFF3.

A second output terminal 313-2 of the third sensing signal copy circuit 310-3 may be connected to a non-inverting (+) terminal of the differential amplifier 321-4 of the fourth differential signal output circuit 320-4. A third output terminal 314-3 of the fourth sensing signal copy circuit 310-4 may be connected to an inverting (−) terminal of the differential amplifier 321-4 of the fourth differential signal output circuit 320-4. Accordingly, the differential amplifier 321-4 of the fourth differential signal output circuit 320-4 may output the difference value between the copy signal output from the third output terminal 314-3 of the fourth sensing signal copy circuit 310-4, i.e., the fourth sensing signal RX4, and the copy signal output from the second output terminal 313-2 of the third sensing signal copy circuit 310-3, i.e., the third sensing signal RX3, as the fourth differential sensing signal.

A first output terminal 314-1 of the fourth sensing signal copy circuit 310-4 may be connected to a non-inverting (+) terminal of the differential amplifier 321-5 of the fifth differential signal output circuit 320-5. A third output terminal 315-3 of the fifth sensing signal copy circuit 310-5 may be connected to an inverting (−) terminal of the differential amplifier 321-5 of the fifth differential signal output circuit 320-5. Accordingly, the differential amplifier 321-5 of the fifth differential signal output circuit 320-5 may output the difference value between the copy signal output from the third output terminal 315-3 of the fifth sensing signal copy circuit 310-5, that is, the fifth sensing signal RX5, and the copy signal output from the first output terminal 314-1 of the fourth sensing signal copy circuit 310-4, that is, the fourth sensing signal RX4, as the fifth differential sensing signal DIFF5.

A first output terminal 315-1 of the fifth sensing signal copy circuit 310-5 may be connected to a non-inverting (+) terminal of the differential amplifier 321-6 of the sixth differential signal output circuit 320-6. A third output terminal 316-3 of the sixth sensing signal copy circuit 310-6 may be connected to an inverting (−) terminal of the differential amplifier 321-6 of the sixth differential signal output circuit 320-6. Accordingly, the differential amplifier 321-6 of the sixth differential signal output circuit 320-6 may output the difference value between the copy signal output from the third output terminal 316-3 of the sixth sensing signal copy circuit 310-6, the sixth sensing signal RX6, and the copy signal output from the first output terminal 315-1 of the fifth sensing signal copy circuit 310-5, i.e., the fifth sensing signal RX5, as the sixth differential sensing signal DIFF6.

On the other hand, referring again to FIG. 5, the touch driving device 300 according to the second embodiment may include a connection control circuit 315.

The connection control circuit 315 may control the connection between the plurality of sensing signal copy circuits 310-1 to 310-6 and the plurality of differential signal output circuits 320-1 to 320-6.

For example, as illustrated in FIGS. 5 and 6, the first output terminal 311-1 of the first sensing signal copy circuit 310-1 may be connected to the first differential signal output circuit 320-1. The connection control circuit 315 may connect the second output terminal 311-2 or the third output terminal 311-3 of the first sensing signal copy circuit 310-1 to the first differential signal output circuit 320-1 instead of the first output terminal 311-1.

For example, the first output terminal 312-1 of the second sensing signal copy circuit 310-2 may be connected to the second differential signal output circuit 320-2, and the third output terminal 312-3 of the second sensing signal copy circuit 310-2 may be connected to the first differential signal output circuit 320-1. The connection control circuit 315 may connect the second output terminal 312-2, instead of the first output terminal 312-1 of the second sensing signal copy circuit 310-2, to the second differential signal output circuit 320-2. The connection control circuit 315 may connect the second output terminal 312-2, instead of the third output terminal 312-3 of the second sensing signal copy circuit 310-2, to the first differential signal output circuit 320-1.

As such, the connection control circuit 315 may selectively connect the plurality of output terminals of the plurality of sensing signal copy circuits 310-1 to 310-6 to at least one differential signal output circuit or may change a previously connected first path to be connected to a second path.

Accordingly, when a problem occurs during an existing connection path, the connection control circuit 315 may be used to form a new connection path using an unused output terminal among the plurality of output terminals, thereby automatically replacing the connection path without having to manually form a new connection path.

The above detailed description should not be construed as limiting in any respect and should be considered illustrative only. The scope of the embodiment should be determined by the reasonable interpretation of the appended claims, and any changes within the equivalent range of the embodiment fall within the scope of the embodiment.

1. A touch driving device, comprising:
a plurality of differential signal output circuits connected to a plurality of channels; and
a plurality of sensing signal copy circuits connected between one channel among the plurality of channels and at least one differential signal output circuit among the plurality of differential signal output circuits,
wherein the plurality of sensing signal copy circuits copy a sensing signal received from the one channel as a plurality of copy signals and output the plurality of copy signals to a plurality of output terminals, respectively, and
wherein the plurality of differential signal output circuits output a differential sensing signal by using one copy signal among the plurality of copy signals output to the plurality of output terminals of an adjacent sensing signal copy circuits, respectively.

2. The touch driving device of claim 1, wherein the plurality of sensing signal copy circuits comprise a first sensing signal copy circuit, a last sensing signal copy circuit, two adjacent sensing signal copy circuits included in a central region, and remaining sensing signal copy circuits.

3. The touch driving device of claim 2, wherein, in each of the first sensing signal copy circuit and the last sensing signal copy circuit, one output terminal among the plurality of output terminals is connected to one corresponding differential signal output circuit.

4. The touch driving device of claim 3, wherein, in each of the two adjacent sensing signal copy circuits included in the central region, three output terminals among the plurality of output terminals are connected to three corresponding differential signal output circuits.

5. The touch driving device of claim 4, wherein, in each of the remaining sensing signal copy circuits, two output terminals among the plurality of output terminals are connected to two corresponding differential signal output circuits.

6. The touch driving device of claim 4, comprising a connection control circuit configured to control connection between the plurality of sensing signal copy circuits and the plurality of differential signal output circuits.

7. The touch driving device of claim 1, wherein the plurality of differential signal output circuits are divided into differential signal output circuits included in a first side region and differential signal output circuits included in a second side region with respect to a center line, and
wherein the differential signal output circuits included in the first side region and the differential signal output circuits included in the second side region perform opposite differential operations.

8. The touch driving device of claim 1, wherein the plurality of sensing signal copy circuits comprise copy signal output circuits, respectively.

9. The touch driving device of claim 1, wherein a number of the plurality of channels, a number of the plurality of differential signal output circuits, and a number of the plurality of sensing signal copy circuits are each n, and
wherein the plurality of sensing signal copy circuits copy the sensing signals as n/2 copy signals.

10. A display device, comprising:
a panel comprising a plurality of touch lines; and
a touch driving device comprising a plurality of channels connected to the plurality of touch lines,
wherein the touch driving device comprises:
a plurality of differential signal output circuits connected to the plurality of channels; and
a plurality of sensing signal copy circuits connected between one channel among the plurality of channels and at least one differential signal output circuit among the plurality of differential signal output circuits,
wherein the plurality of sensing signal copy circuits copy a sensing signal received from the one channel as a plurality of copy signals and output the plurality of copy signals to a plurality of output terminals, respectively, and
wherein the plurality of differential signal output circuits output a differential sensing signal by using one copy signal among the plurality of copy signals output to the plurality of output terminals of an adjacent sensing signal copy circuits, respectively.

11. The display device of claim 10, wherein the plurality of sensing signal copy circuits comprise a first sensing signal copy circuit, a last sensing signal copy circuit, two adjacent sensing signal copy circuits included in a central region, and remaining sensing signal copy circuits.

12. The display device of claim 11, wherein, in each of the first sensing signal copy circuit and the last sensing signal copy circuit, one output terminal among the plurality of output terminals is connected to one corresponding differential signal output circuit.

13. The display device of claim 12, wherein, in each of the two adjacent sensing signal copy circuits included in the central region, three output terminals among the plurality of output terminals are connected to three corresponding differential signal output circuits.

14. The display device of claim 13, wherein, in each of the remaining sensing signal copy circuits, two output terminals among the plurality of output terminals are connected to two corresponding differential signal output circuits.

15. The display device of claim 13, comprising a connection control circuit configured to control connection between the plurality of sensing signal copy circuits and the plurality of differential signal output circuits.

16. The display device of claim 10, wherein the plurality of differential signal output circuits are divided into differential signal output circuits included in a first side region and differential signal output circuits included in a second side region with respect to a center line, and
wherein the differential signal output circuits included in the first side region and the differential signal output circuits included in the second side region are configured to perform opposite differential operations.

17. The display device of claim 10, wherein the plurality of sensing signal copy circuits comprise copy signal output circuits, respectively.

18. The display device of claim 10, wherein a number of the plurality of channels, a number of the plurality of differential signal output circuits, and a number of the plurality of sensing signal copy circuits are each n, and
wherein the plurality of sensing signal copy circuits are configured to copy the sensing signals as n/2 copy signals.
